(19) United States
(12) Patent Application Publication
(10) Pub. No.: US 2026/0252690 A1
(43) Pub. Date: Aug. 27, 2026

(54) METHODS TO DETECT GLITCH ATTACKS AND ENFORCE PRECAUTIONARY COUNTERMEASURES

(71) Applicant: Micron Technology, Inc., Boise, ID (US)

(72) Inventors: Giuseppe Cariello, Boise, ID (US); Sourin Sarkar, Bangalore (IN)

(21) Appl. No.: 19/541,898

(22) Filed: Feb. 17, 2026

Related U.S. Application Data
(60) Provisional application No. 63/763,000, filed on Feb. 25, 2025.

(51) Int. Cl. G06F 21/55; G06F 21/57

(52) U.S. Cl. CPC G06F 21/554; G06F 21/572; G06F 2221/034

(57) ABSTRACT

Systems and methods are disclosed, including a memory system that includes a memory array and a memory controller. The memory array includes memory cells that are included in one or more memory devices. The memory controller is operatively coupled to the one or more memory devices and configured to detect anomalies in the memory devices, store anomaly data for the detected anomalies in the memory array, detect when the stored anomaly data indicates an external attack, and initiate a countermeasure operation included in firmware of the memory controller in response to detecting the external attack.

### PRIORITY APPLICATION

This application claims the benefit of priority to U.S. Provisional Application Ser. No. 63/763,000, filed Feb. 25, 2025, which is incorporated herein by reference in its entirety.

### BACKGROUND

Memory devices are semiconductor circuits that provide electronic storage of data for a host system (e.g., a computer or other electronic device). Memory devices may be volatile or non-volatile. Volatile memory requires power to maintain data and includes devices such as random-access memory (RAM), static random-access memory (SRAM), dynamic random-access memory (DRAM), or synchronous dynamic random-access memory (SDRAM), among others.

Host systems (or hosts) typically include a host processor, a first amount of main memory (e.g., often volatile memory, such as DRAM) to support the host processor, and one or more memory systems (e.g., often non-volatile memory, such as flash memory, and may include volatile memory) that provide additional storage to retain data in addition to or separate from the main memory.

A memory system can include a memory controller and one or more memory devices, including a number of dies or logical units (LUNs). In certain examples, each die can include a number of memory arrays and peripheral circuitry thereon, such as die logic or a die processor. The memory controller can include interface circuitry configured to communicate with a host device (e.g., the host processor or interface circuitry) through a communication link (e.g., a bidirectional parallel or serial communication interface). The memory controller can receive commands or operations from the host system in association with memory operations or instructions, such as read or write operations to transfer data (e.g., user data and associated integrity data, such as error data or address data, etc.) between the memory devices and the host device, erase operations to erase data from the memory devices, perform drive management operations (e.g., data migration, garbage collection, block retirement), etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example computing system including a host system and a memory system.

FIG. 2 is a block diagram of portions of an example of a memory system.

FIG. 3 is a block diagram of an example of a computing system with capability to detect and mitigate glitch attacks.

FIG. 4 is a flow diagram of an example of a method of operating a computing system.

FIG. 5 illustrates an example block diagram of a computing system.

### DETAILED DESCRIPTION

Software (e.g., programs), instructions, operating systems (OS), and other data are typically stored on storage systems and accessed for use by a host processor. Main memory (e.g., RAM) is typically faster, more expensive, and a different type of memory device (e.g., volatile) than a majority of the memory devices of the memory system (e.g., non-volatile, such as an SSD, etc.). In addition to the main memory, host devices can include different levels of volatile memory, such as a group of static memory (e.g., a cache, often SRAM), often faster than the main memory, in certain examples, configured to operate at speeds close to or exceeding the speed of the host processor, but with lower density and higher cost.

Computing systems that include host systems and memory storage systems can be embedded systems used in, among other things, automotive applications and smart phone applications. Embedded systems can be the target of external attacks to gain unauthorized access to the resources controlled by an embedded system. For instance, a fault injection attack or glitch attack targets an embedded device by intentionally introducing faults into the device to disrupt its normal operation. The disruptions can potentially bypass security mechanisms of the embedded devices to allow the attacker to gain unauthorized access to the resource controlled using the embedded system, such as access or control of a vehicle.

Memory devices include individual memory die, which may, for example, include a storage region comprising one or more arrays of memory cells, implementing one (or more) selected storage technologies. Such memory die will often include support circuitry for operating the memory array(s). Other examples, sometimes known generally as “managed memory devices,” include assemblies of one or more memory die associated with controller functionality configured to control operation of the one or more memory dies. Such controller functionality can simplify interoperability with an external host device. In such managed memory devices, the controller functionality may be implemented on one or more dies also incorporating a memory array, or on a separate die. In other examples, one or more memory devices may be combined with controller functionality to form a solid-state drive (SSD) storage volume.

Embodiments of the present disclosure are described in the example of managed memory devices implementing NAND flash memory cells. These examples can be referred to as managed NAND or mNAND devices. These examples, however, are not limiting on the scope of the disclosure, which may be implemented in other forms of memory devices and/or with other forms of storage technology.

Both NOR and NAND flash architecture semiconductor memory arrays are accessed through decoders that activate specific memory cells by selecting the word line coupled to their gates. In a NOR architecture semiconductor memory array, once activated, the selected memory cells place their data values on bit lines, causing different currents to flow depending on the state at which a particular cell is programmed. In a NAND architecture semiconductor memory array, a high bias voltage is applied to a drain-side select gate (SGD) line. Word lines coupled to the gates of the unselected memory cells of each group are driven at a specified pass voltage (e.g., Vpass) to operate the unselected memory cells of each group as pass transistors (e.g., to pass current in a manner unrestricted by their stored data values). Current then flows from the source line to the bit line through each series coupled group, restricted only by the selected memory cells of each group, placing current encoded data values of selected memory cells on the bit lines.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can also represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices may be configured and operated in accordance with recognized industry standards. For example, managed NAND devices may be (as non-limiting examples), a Universal Flash Storage (UFS™) device, or an embedded MMC device (eMMC™), etc. For example, in the case of the above examples, UFS devices may be configured in accordance with Joint Electron Device Engineering Council (JEDEC) standards (e.g., JEDEC standard JESD223D, entitled JEDEC UFS Flash Storage 3.0, etc., and/or updates or subsequent versions to such standard). Similarly, identified eMMC devices may be configured in accordance with JEDEC standard JESD84-A51, entitled “JEDEC eMMC standard 5.1”, again, and/or updates or subsequent versions to such standard.

An SSD can be used as, among other things, the main storage device of a computer, having advantages over traditional hard drives with moving parts with respect to, for example, performance, size, weight, ruggedness, operating temperature range, and power consumption. For example, SSDs can have reduced seek time, latency, or other delay associated with magnetic disk drives (e.g., electromechanical, etc.). SSDs use non-volatile memory cells, such as flash memory cells to obviate internal battery supply requirements, thus allowing the drive to be more versatile and compact. Managed memory devices, for example managed NAND devices, can be used as primary or ancillary memory in various forms of electronic devices, and are commonly used in mobile devices.

Managed memory devices can include a number of memory devices, including a number of dies or logical units (e.g., logical unit numbers or LUNs), and can include one or more processors or other controllers performing logic functions required to operate the memory devices or interface with external systems. Such managed memory devices can include one or more flash memory dies, including a number of memory arrays and peripheral circuitry thereon. The flash memory arrays can include a number of blocks of memory cells organized into a number of physical pages. Managed NAND devices can include one or more arrays of volatile and/or nonvolatile memory separate from the NAND storage array, and either within or separate from a controller. Both SSDs and managed NAND devices can receive commands from a host or a host in association with memory operations, such as read or write operations to transfer data (e.g., user data and associated integrity data, such as error data and address data, etc.) between the memory devices and the host, or erase operations to erase data from the memory devices.

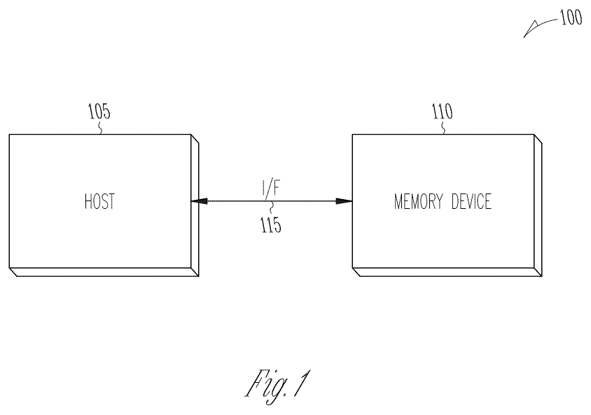

FIG. 1 illustrates an example computing system 100 including a host 105 and a memory system 110. The host 105 can include a host processor, a central processing unit, or one or more other device, processor, or controller. The memory system 110 can include one or more other memory devices, and the communication interface 115 (I/F) can include one or more other interfaces, depending on the host 105 and the memory system 110. Each of the host 105 and the memory system 110 can include a number of receiver or driver circuits configured to send or receive signals over the communication interface 115, or interface circuits, such as data control units, sampling circuits, or other intermedia circuits configured to process data to be communicated over, or otherwise process data received from the communication interface 115 for use by the host 105, the memory system 110, or one or more other circuits or devices.

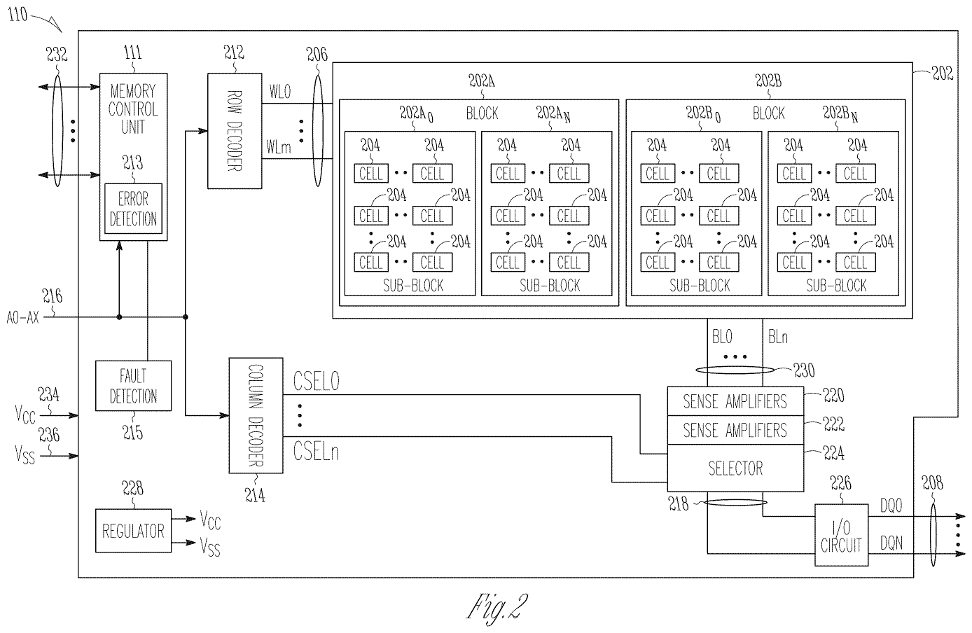

FIG. 2 illustrates an example block diagram of portions of a memory system 110 including a memory array 202 having a plurality of memory cells 204, and one or more circuits or components to provide communication with, or perform one or more memory operations on, the memory array 202. Although shown with a single memory array 202, in other examples, one or more additional memory arrays, dies, or LUNs can be included herein. The memory system 110 can include a row decoder 212, a column decoder 214, sense amplifiers 220, a page buffer 222, a selector 224, an input/output (I/O) circuit 226, and a memory controller 211.

The memory cells 204 of the memory array 202 can be arranged in blocks, such as first and second blocks 202A, 202B. Each block can include sub-blocks. For example, the first block 202A can include first and second sub-blocks 202A₀, 202Aₙ, and the second block 202B can include first and second sub-blocks 202B₀, 202Bₙ. Each sub-block can include a number of physical pages, each page including a number of memory cells 204. Although illustrated herein as having two blocks, each block having two sub-blocks, and each sub-block having a number of memory cells 204, in other examples, the memory array 202 can include more or fewer blocks, sub-blocks, memory cells, etc. In other examples, the memory cells 204 can be arranged in a number of rows, columns, pages, sub-blocks, blocks, etc., and accessed using, for example, access lines 206, first data lines 230, or one or more select gates, source lines, etc.

The memory controller 211 can control memory operations of the memory system 110 according to one or more signals or instructions received on control lines 232, including, for example, one or more clock signals or control signals that indicate a desired operation (e.g., write, read, erase, etc.), or address signals (A0-AX) received on one or more address lines 216. One or more devices external to the memory system 110 can control the values of the control signals on the control lines 232, or the address signals on the address line 216. Examples of devices external to the memory system 110 can include, but are not limited to, a host, a memory controller, a processor, or one or more circuits or components not illustrated in FIG. 2.

The memory system 110 can use access lines 206 and first data lines 230 to transfer data to (e.g., a write or erase operation) or from (e.g., a read operation) one or more of the memory cells 204. The row decoder 212 and the column decoder 214 can receive and decode the address signals (A0-AX) from the address line 216, can determine which of the memory cells 204 are to be accessed, and can provide signals to one or more of the access lines 206 (e.g., one or more of a plurality of word lines (WL0-WLm)) or the first data lines 230 (e.g., one or more of a plurality of bit lines (BL0-BLn)), such as described above.

The memory system 110 can include sense circuitry, such as the sense amplifiers 220, configured to determine the values of data on (e.g., read), or to determine the values of data to be written to, the memory cells 204 using the first data lines 230. For example, in a selected string of memory cells 204, one or more of the sense amplifiers 220 can read a logic level in the selected memory cell 204 in response to a read current flowing in the memory array 202 through the selected string to the data lines 230.

One or more devices external to the memory system 110 can communicate with the memory system 110 using the I/O lines (DQ0-DQN) 208, address lines 216 (A0-AX), or control lines 232. The input/output (I/O) circuit 226 can transfer values of data in or out of the memory system 110, such as in or out of the page buffer 222 or the memory array 202, using the I/O lines 208, according to, for example, the control lines 232 and address lines 216. The page buffer 222 can store data received from the one or more devices external to the memory system 110 before the data is programmed into relevant portions of the memory array 202 or can store data read from the memory array 202 before the data is transmitted to the one or more devices external to the memory system 110.

The column decoder 214 can receive and decode address signals (A0-AX) into one or more column select signals (CSEL0-CSELn). The selector 224 (e.g., a select circuit) can receive the column select signals (CSEL0-CSELn) and select data in the page buffer 222 representing values of data to be read from or to be programmed into memory cells 204. Selected data can be transferred between the page buffer 222 and the I/O circuit 226 using second data lines 218.

The memory controller 211 can receive positive and negative supply signals, such as a supply voltage (Vcc) 234 and a negative supply (Vss) 236 (e.g., a ground potential), from an external source or supply (e.g., an internal or external battery, an AC-to-DC converter, etc.). In certain examples, the memory controller 211 can include a regulator 228 to internally provide positive or negative supply signals.

The memory controller 211 includes error detection circuitry 213 to detect errors in memory data. In certain examples, the error detection circuitry 213 may detect errors using, among other things, cyclic redundancy check (CRC) and may detect and correct errors using Error Correcting Code (ECC). The error detection circuitry 213 may detect errors in memory read data and in memory write data. The memory controller 211 may also include circuitry to detect address faults, firmware loading faults, and configuration fuse faults.

The computing system 100 of FIG. 1 may have a safety-critical application such as autonomous operation or partially autonomous operation of a vehicle or industrial machine. A memory system fault can cause errors in data and can also impact the ability of the error detection circuitry 213 to detect memory data errors. This can result in one or more of corrupt data being returned to the host 105, data read from the wrong address being returned to the host 105, loss of data from the host 105, data from the host being written to the wrong address, or failure of the memory system 110 to respond to a command from the host 105. The computing system 100 for a safety-critical application may incorporate safety mechanisms to avoid or resolve system failures.

The memory system 110 in FIG. 2 includes fault detection circuitry 215 to detect faults in the memory system 110. The fault detection circuitry 215 can include logic circuitry and sensing circuitry to detect system faults in the memory system 110, such as clock faults, voltage faults, and other faults that affect overall function of the memory system. For example, the fault detection circuitry 215 can include one or more voltage or current sensing circuits to detect a fault in the circuit supply of the memory system 110. The fault detection circuitry 215 can include a clock monitor circuit to detect a clock fault in the memory system 110. The fault detection circuitry 215 can include logic circuitry to detect a firmware fault in the memory system 110. The fault detection circuitry 215 can include other circuitry to detect further examples of memory system faults.

As described previously herein, fault injection attacks or glitch attacks target embedded devices by intentionally introducing faults to disrupt the normal operation of an embedded device. These external attacks on the device can be performed using various methods. Voltage glitching alters the supply voltage of the devices to cause errors in operation of the devices. Clock glitching manipulates one or more clock signals of the devices to create timing errors. Electromagnetic pulses can be applied to the devices to induce faults by electromagnetic interference. Laser fault injection focuses a laser beam on circuits to cause local faults in the circuit silicon and perturbate normal silicon behavior.

The faults introduced by the external attacks can corrupt instructions and data stored in the memory systems. The attacks may access protected areas of memory, such as a Replay Protected Memory Block (RPMB) area of a memory device. The corruption of instructions and data can potentially bypass security mechanisms of embedded systems and allow the attacker to gain unauthorized access or control.

To prevent glitch attacks, embedded systems can include hardware to detect the glitch attacks. More robust hardware that can withstand glitch attacks can be added to host systems to prevent the attacks. Error mitigation techniques implemented in the memory systems can be used as a second line of defense in detecting and preventing glitch attacks. For instance, the memory system 110 includes error detection circuitry 213 to detect errors in data stored in memory. The stored data can include read and write data, instruction pointers, and program counters of the memory system. The memory system 110 also includes fault detection circuitry 215 to detect system faults in the memory system 110, such as clock faults, voltage faults, and other system faults. Checking for memory data errors and monitoring certain aspects of the occurrence of the errors can lead to detection of errors in the memory that are being caused by a glitch attack rather than errors that typically occur only from operation of the memory system. Similarly, checking for memory system faults and monitoring certain aspects of the occurrence of the faults can lead to detection of faults that are being caused by a glitch attack.

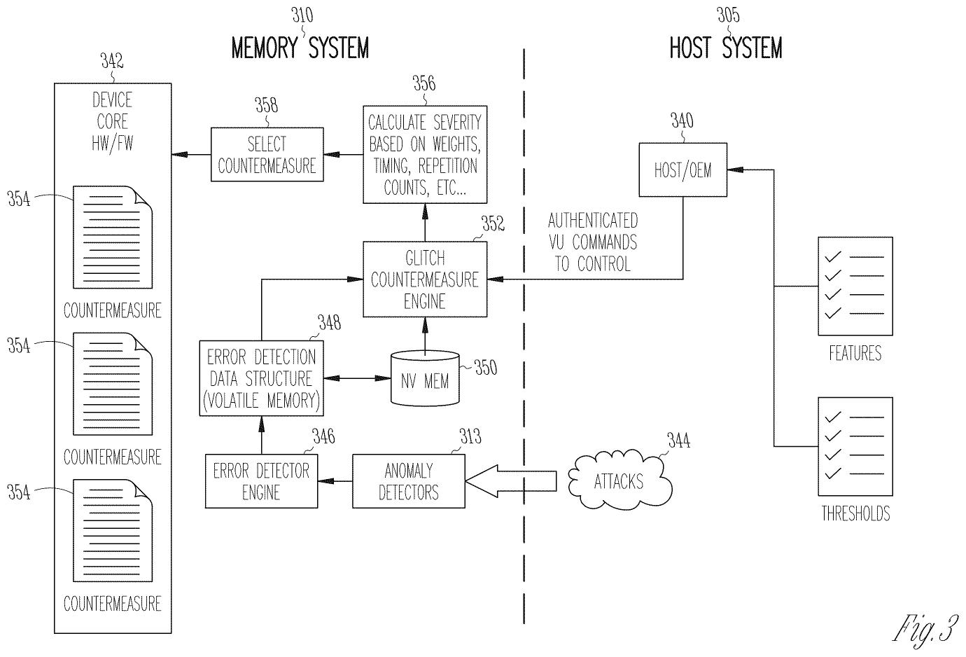

FIG. 3 is a block diagram of an example of a computing system with capability to detect and mitigate glitch attacks. To the right in the diagram are blocks related to the domain of the host system 305 that can include processing circuitry 340 (one or more host processors) that executes instructions included in OEM software. To the left in the diagram are blocks related to the domain of the memory system 310 that is a managed memory system (e.g., mNAND). The memory system 310 includes a memory controller (e.g., memory controller 211 of FIG. 2) and a memory array (e.g., memory array 202 of FIG. 2). The blocks of the domain of the memory system 310 may be included in a memory controller or the memory array of the memory system. The memory system 310 includes a memory controller core 342. The memory controller core 342 includes processing circuitry, such as a processor core that executes instructions in firmware of the memory system 310 to perform the functions described for the memory controller 311 such as performing read operations and write operations in response to commands from the host system 305.

The attacks 344 external to the memory system 310 represent any type of glitch attack or fault injection attack including voltage glitching, clock glitching, electromagnetic pulses, laser fault injection, and other external attacks. The memory system 310 includes anomaly detectors 313 to detect disruptions caused by the attacks. Examples of the anomaly detectors 313 include memory data error detection circuitry (e.g., error detection circuitry 213 of FIG. 2) and memory system fault detection circuitry (e.g., fault detection circuitry 215 of FIG. 2). Anomaly detectors can also be software components (e.g., the result of a cryptographic evaluation).

The memory system 310 may include an error detector engine 346 that includes logic to identify anomalies and produce anomaly information using the output of the anomaly detectors 313. The error detector engine 346 may be included in the memory controller of the memory system or be implemented in firmware. The anomaly information collected is different from only data errors or system faults and provides clues whether the data errors and system fault information are part of an external attack on the computer system.

In some examples, the anomaly information includes counts for different types of the anomalies and the time between anomalies. For instance, the anomaly information may include one or more of a count of the number of memory bit errors detected, the time between detection of the bit errors, and the time duration over which the bit errors were detected. If the number of bit errors significantly increases over a short amount of time, the frequency of the bit errors increases, or time between the occurrence of bit errors is regular instead of random, these may be indications of an external attacker trying to disrupt the memory operation (e.g., an external device causing glitches in the memory data). Other anomaly information may include counts of instruction register errors, instruction pointer errors, and timing related to the instruction register errors and instruction pointer errors.

The same approach can be applied to the memory system fault detection. The anomaly information may include one or more of a count of the number of system faults detected, such as clock faults, voltage faults, and other system faults. The anomaly information may include the time between detection of system faults and the time duration over which the system faults were detected. If the count of system faults significantly increases over a short amount of time, the frequency of the system faults increases, or time between the occurrence of system faults is regular instead of random, these may be indications of an external influence trying to disrupt the memory system.

The anomaly information can include information other than error information and system fault information. For instance, an external attack may involve an attempt to access protected memory storage (e.g., a Replay Protected Memory Block). The protected memory storage may store biometric information used to grant access or control, financial information, or key material used to produce keys for authentication of users. The memory controller can include logic circuits or firmware logic to detect attempts to access protected memory storage and collect anomaly information related to the attempts.

For instance, the anomaly information can include one or more a count of the number of unsuccessful attempts to access the protected memory storage of the memory system. The unsuccessful attempts may include, among other things, receiving an incorrect authentication code (e.g., a Hash-Based Authentication Code, or HMAC) needed to access the protected memory storage or receiving an incorrect key (e.g., an RSA authentication key) needed to access the protected memory storage. The anomaly information can include the time between the attempts to access the protected memory storage, and the time duration over which the attempts to access the protected memory storage were detected. If the count of unsuccessful attempts to access protected memory storage significantly increases over a specified amount of time or the frequency of the attempts increases, this may be an indication of an attacker trying to make unauthorized attempts to access the protected memory storage.

The memory controller includes logic to detect that a glitch attack is likely responsible for the anomaly information collected by the memory system 310. The logic may be included in a glitch countermeasure engine 352 that reads the recorded anomaly information to detect a glitch attack. The memory controller core 342 includes countermeasure logic 354 that changes the operation of the memory controller in response to detection of a glitch attack. The countermeasure logic 354 can include countermeasure operations performable by the firmware (FW) of the memory controller core 342. The countermeasure operations are designed to mitigate a detected glitch attack. The memory controller core 342 performs a countermeasure in response to the glitch countermeasure engine 352 detecting the glitch attack.

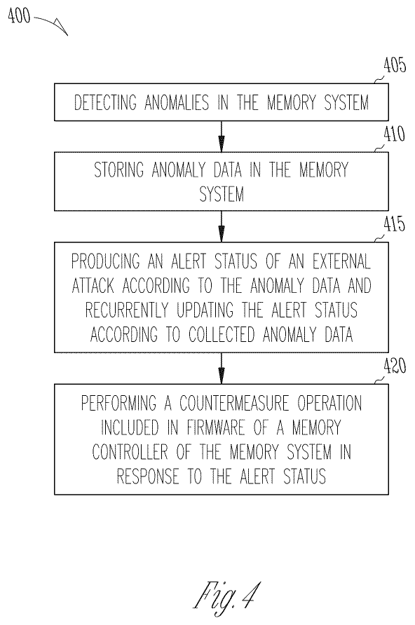

FIG. 4 is a flow diagram of an example of a method 400 of operating a computing system (e.g., the computing system of FIG. 3). The method 400 detects and mitigates glitch attacks on the computing system. At block 405, anomalies in the memory system are detected. The anomalies may be detected using the error detector engine 346 in FIG. 3 and anomaly information is produced using output from one or more anomaly detectors 313.

At block 410, the memory controller stores the anomaly information in the memory array. The memory controller may store the anomaly information in volatile memory as one or more error detection data structures 348. In some examples, the memory controller stores the anomaly information (e.g., as data structures) in non-volatile memory 350 to maintain the alert status while the risk conditions persist. In some examples, the anomaly information is encrypted and stored in protected non-volatile memory storage to prevent tampering with the anomaly information by an attacker.

At block 415, the alert status of an external attack is recurrently updated according to the latest collected anomaly information. The logic of the glitch countermeasure engine 352 of the memory controller applies one or more logic rules to the anomaly information to detect a glitch attack to produce the alert. The logic rules may include threshold counts or repetition counts for specific types of anomalies that are detected before a glitch attack is declared. The logic rules may include combinations of counts and time durations for specific types of anomalies. The logic rules may weigh different types of detected anomalies differently. For instance, meeting or exceeding different threshold counts for different types of anomalies may trigger a glitch attack alert. The glitch countermeasure engine 352 may include logic to calculate severity of the glitching attach 356 declared using the counts, timing, and weights of the anomaly information.

At block 420, the countermeasure logic of the memory controller initiates a countermeasure operation included in firmware in response to the alert. For instance, the alert may include activating a flag in a memory register, and initiating the countermeasure may involve branching to a countermeasure routine in the firmware when the flag is active. In some examples, the countermeasure logic 354 initiates a countermeasure operation that changes a time delay in execution of a critical routine of the firmware in response to the detection of a glitch attack. The critical routine may involve receiving a command using the protected memory storage and calculating an authentication code for the command. The countermeasure logic 354 may insert or change a random delay in the routine between the receiving and decoding of the memory command and the calculation of the authentication code. This varying delay in the critical routine may make it difficult for the attacker to hit a critical time window between the calculation of the authentication code and the decision by the memory controller of the authenticity of the code. If the countermeasure increases the time of the delay, the countermeasure may include the memory controller using the delay time to scan memory for data bit errors, or to execute and check a dummy authentication calculation to make it difficult for the attacker to hit the critical time window.

In another example, the countermeasure logic may increase the number of times that an authentication routine in the firmware of the memory controller needs to be performed before authentication is determined. The authentication routine may be a routine to authenticate a credential to gain access to a resource or may be a routine to authenticate communication with the computer system. Performing the authentication routine multiple times makes it more difficult for an attacker to succeed in an unauthorized access. If an unsuccessful attempt at authentication is detected over the multiple iterations of the authentication routine, the countermeasure logic 354 may provide for the memory controller to perform further countermeasures.

For instance, the memory controller may change from performing the authentication routine once for one authentication, to performing the authentication routine twice to require two authentications when a glitch attack is first detected. If either of the two attempts at authentication fail, the memory controller may record the unsuccessful attempt or attempts and increase the count of unsuccessful attempts at authentication. In response to the increase of the counter, the memory controller may enter an even higher alert level of countermeasures. For instance, the memory controller may promptly timeout the command being attempted and may require a hardware reset to continue. The memory controller may add more delay to the authentication routine or may again increase the number of times the authentication routine is performed. In some examples, the higher alert level of countermeasures includes increasing the sensitivity of anomaly detection and glitch attack detection by the glitch countermeasure engine 352. In some examples, the higher alert level of countermeasures can result in a higher determination of severity by the glitch countermeasure engine 352. Conversely, if both of the two attempts at authentication are successful, the countermeasure logic 354 may decrease the count of unsuccessful authentications and change to a lower alert level of countermeasures to return to faster functioning of the computing system.

The countermeasure logic 354 of the memory controller core 342 may include instructions to perform more than one countermeasure in response to a glitch attack. The memory controller may store a mapping of detectable anomaly types to multiple countermeasures encoded in the firmware. The mapping may include a stored table of countermeasure operations. The glitch countermeasure engine 352 may include logic to select a countermeasure operation 358 based on the anomaly information. The countermeasure operation is selected from the table by the glitch countermeasure engine 352 based on one or more of the type of anomalies, the counts of the type of anomalies, and the timing of the anomalies. Logic used to select countermeasures can be changed based on severity of the anomaly detected. The severity calculation and countermeasure logic 354 can be implementation dependent. The countermeasure logic 354 for a specific implementation can be pre-trained and use preset weights and thresholds when the system is shipped or installed.

The logic of one or both of the glitch countermeasure engine 352 and the countermeasure logic 354 can be changed by the OEM software of the host processing circuitry. The OEM software can program the logic using specialized vendor unique (VU) commands. The VU commands are non-protocol commands that are encapsulated in protocol commands (e.g., a WRITE BUFFER command. To provide adequate security, either the VU command or the encapsulating command needs to be authenticated to ensure that only an authorized entity can issue the command. Changing the logic of the glitch countermeasure engine 352 and the countermeasure logic 354 changes the behavior of the memory system in responding to glitch attacks. The VU commands can be used to control how reactive the memory system 310 is with respect to glitch attacks. The VU commands can be used to enable and disable features and detection thresholds of the countermeasure logic 354. The VU commands can be used to make the glitch countermeasure engine 352 more reactive or less reactive to glitch attacks by changing the sensitivity of the criteria to detect a glitch attack. The VU commands can be used to change the mapping of the anomaly information to the countermeasure operations and change the aggressiveness of the countermeasures to mitigate the glitch attack (e.g., by changing a table mapping the anomaly information to countermeasures to be performed to mitigate the attack).

The systems and methods described herein detect and mitigate glitch attacks on computing systems using circuits of a memory system. The techniques can be implemented in firmware of the memory system using error and fault circuits that may also be used by the memory system to detect memory system errors. This allows the glitching detection techniques to be easily modified by changing the logic of the firmware if changing threats are discovered. Updates to the glitching detection techniques can be deployed in the field through field firmware updates.

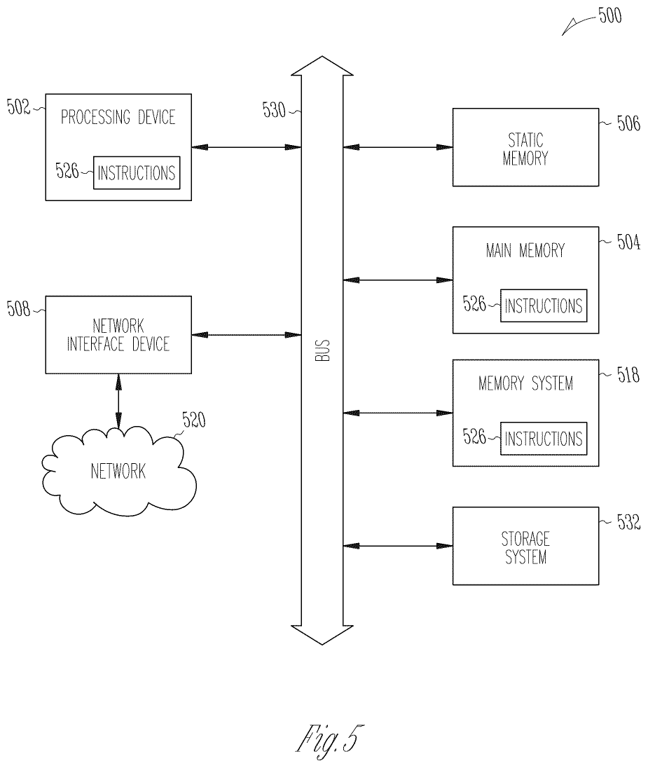

FIG. 5 illustrates a block diagram of an example machine 500 (e.g., a computing system) upon which any one or more of the techniques (e.g., methodologies) discussed herein may be performed. In alternative embodiments, the machine 500 may operate as a standalone device or may be connected (e.g., networked) to other machines. In a networked deployment, the machine 500 may operate in the capacity of a network node. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, an IoT device, an automotive computing system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 500 (e.g., computing system) may include a processing device 502 (e.g., a hardware processor, a central processing unit (CPU), a graphics processing unit (GPU), a hardware processor core, or any combination thereof, etc.), a main memory 504 (e.g., read-only memory (ROM), dynamic random-access memory (DRAM) such as synchronous DRAM (SDRAM) or Rambus DRAM (RDRAM), etc.), a static memory 506 (e.g., static random-access memory (SRAM), etc.), a memory system 510, and a storage system 532, some or all of which may communicate with each other via a communication interface (e.g., a bus) 530.

The processing device 502 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), network processor, or the like. The processing device 502 can be configured to execute instructions 526 for performing the operations and steps discussed herein. The computer system can further include a network interface device 508 to communicate over a network 520.

The memory system 510 can include a machine-readable storage medium (also known as a computer-readable medium) on which is stored one or more sets of instructions 526 or software embodying any one or more of the methodologies or functions described herein. The instructions 526 can also reside, completely or at least partially, within the main memory 504 or within the processing device 502 during execution thereof by the computer system, the main memory 504 and the processing device 502 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 500 may further include a display unit, an alphanumeric input device (e.g., a keyboard), and a user interface (UI) navigation device (e.g., a mouse). In an example, one or more of the display units, the input device, or the UI navigation device may be a touch screen display. The machine may include a signal generation device (e.g., a speaker), or one or more sensors, such as a global positioning system (GPS) sensor, compass, accelerometer, or one or more other sensors. The machine 500 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 526 (e.g., software, programs, an operating system (OS), etc.) or other data stored on the storage system 532 can be accessed by the main memory 504 for use by the processing device 502. The main memory 504 (e.g., DRAM) is typically fast, but volatile, and thus a different type of storage than the storage system 532 (e.g., an SSD), which is suitable for long-term storage, including while in an “off” condition. The instructions 526 or data in use by a user or the machine 500 are typically loaded in the main memory 504 for use by the processing device 502. When the main memory 504 is full, virtual space from the memory system 510 can be allocated to supplement the main memory 504; however, because the memory system 510 device is typically slower than the main memory 504, and write speeds are typically at least twice as slow as read speeds, use of virtual memory can greatly reduce user experience due to storage system latency (in contrast to the main memory 504, e.g., DRAM). Further, use of the storage system 532 for virtual memory can greatly reduce the usable lifespan of the storage system 532.

The instructions 526 may further be transmitted or received over a network 520 using a transmission medium via the network interface device 508 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, peer-to-peer (P2P) networks, among others). In an example, the network interface device 508 may include one or more physical jacks (e.g., Ethernet, coaxial, or phone jacks) or one or more antennas to connect to the network 520. In an example, the network interface device 508 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 500, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

In some embodiments described herein, different doping configurations may be applied to a select gate source (SGS), a control gate (CG), and a select gate drain (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (i.e., the memory cell may be programmed to an erased state).

According to one or more embodiments of the present disclosure, a memory control unit (e.g., a processor, controller, firmware, etc.) located internal or external to a memory system, is capable of determining (e.g., selecting, setting, adjusting, computing, changing, clearing, communicating, adapting, deriving, defining, utilizing, modifying, applying, etc.) that a memory data error occurs during a memory operation and a memory system fault occurs. The memory control unit may be configured to coordinate reporting of detection of memory data errors with detection of memory system faults.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 includes subject matter (such as a memory system) comprising a memory array including memory cells that are included in one or more memory devices, and a memory controller operatively coupled to the one or more memory devices. The memory controller is configured to detect anomalies in the memory devices, store anomaly data for the detected anomalies in the memory array, and initiate a countermeasure operation included in firmware of the memory controller in response to detecting the external attack.

In Example 2, the subject matter of Example 1 optionally includes a memory controller configured to insert a random delay in execution of an authentication routine of the firmware in response to detecting the external attack.

In Example 3, the subject matter of one or both of Examples 1 and 2 optionally includes a memory controller configured to perform an authentication routine of the firmware multiple times for authentication in response to detecting the external attack.

In Example 4, the subject matter of Example 3 optionally includes memory controller configured to detect an unsuccessful attempt of authentication in the authentication routine of the firmware; and initiate, in response to detecting the unsuccessful attempt, a countermeasure that includes one or more of timing out a command, changing a delay in execution of the authentication routine, increasing a number of times the authentication is performed for authentication, and changing sensitivity of anomaly detection.

In Example 5, the subject matter of one or any combination of Examples 1-4 optionally includes a memory controller configured to store a count of detections of a type of anomaly and time between detections of the type of anomaly.

In Example 6, the subject matter of Example 5, optionally includes a memory controller that includes bit error detection circuitry. The memory controller is optionally configured to store one or more of a count of memory bit errors and a time between memory bit errors, a count of instruction register errors and a time between instruction register errors, and a count of instruction pointer errors and a time between instruction pointer errors.

In Example 7, the subject matter of one or both of Examples 5 and 6 optionally includes voltage sensing circuitry, and optionally includes a memory controller configured to store a count of voltage level errors and a time between voltage level errors.

In Example 8, the subject matter of one or any combination of Examples 5-7 optionally includes a memory controller configured to store a count of unsuccessful attempts to access protected memory storage of the memory system and a time between the unsuccessful attempts to access the protected memory storage.

In Example 9, the subject matter of one or any combination of Examples 1-8 optionally includes a memory controller configured to store respective counts of detections of respective types of anomalies in the memory array; and select a countermeasure performable by the firmware according to the stored respective counts of the detections of respective types of anomalies.

In Example 10, the subject matter of Example 9 optionally includes a memory controller configured to store a mapping of detectable anomaly types to multiple countermeasures encoded in the firmware, and select the countermeasure to initiate from the stored mapping according to the stored respective counts of the detections of respective types of anomalies.

In Example 11, the subject matter of Example 10 optionally includes a memory controller is configured to weigh the stored respective counts of the detections of the respective types of anomalies differently when selecting the countermeasure.

In Example 12, the subject matter of one or any combination of Examples 1-11 optionally includes a memory array that includes non-volatile memory, and a memory controller configured to store the anomaly data in the non-volatile memory.

Example 13 includes subject matter (such as a method of operating a memory system) or can optionally be combined with one or any combination of Examples 1-12 to include such subject matter, comprising detecting anomalies in the memory system, storing anomaly data in the memory system, producing an alert status of an external attack according to the anomaly data and recurrently updating the alert status according to collected anomaly data, and performing a countermeasure operation included in firmware of a memory controller of the memory system in response to the alert status.

In Example 14, the subject matter of Example 13 optionally includes the memory controller performing firmware instructions that insert a random delay in execution of an authentication routine of the firmware in response to the alert status.

In Example 15, the subject matter of one or both of Examples 13 and 14 optionally includes the memory controller increasing a number of times that an authentication routine of the firmware is performed by the memory controller for authentication in response to the alert status.

In Example 16, the subject matter of Example 15 optionally includes detecting an unsuccessful attempt of authentication using the authentication routine; and performing, by the memory controller in response to the unsuccessful attempt in authentication, one or more of timing out a command, changing a delay in execution of the authentication routine, increasing a number of times the authentication is performed for authentication, and changing sensitivity of anomaly detection.

In Example 17, the subject matter of one or any combination of Examples 13-16 optionally includes storing a count of detections of a type of anomaly and time between detections of the type of anomaly, and updating the alert status when the count of detections and time between detections meet thresholds for detection of a glitch attack.

In Example 18, the subject matter of one or any combination of Examples 13-17 optionally includes changing firmware of a memory controller of the memory system to change detection criteria for detecting the external attack and a change countermeasure for the external attack.

Example 19 includes subject matter (or can optionally be combined with one or any combination of Examples 1-18 to include such subject matter) such as a computer readable storage medium comprising instructions that when performed by processing circuitry of a memory controller of a memory system, cause the memory controller to perform operations including detecting anomalies in the memory system; storing anomaly data in the memory system; producing an alert status of an external attack according to the anomaly data; and branching to instructions that cause the memory controller to perform a countermeasure operation to the external attack in response to the alert status.

In Example 20, the subject matter of Example 19 optionally includes a computer readable storage medium including instructions that cause the memory controller to perform a countermeasure operation include instructions that cause the memory controller to perform operations including one or both of inserting a random delay in execution of instructions of a routine performed by the memory controller, and changing a frequency with which the memory controller performs an authentication routine.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory system comprising:
a memory array including memory cells that are included in one or more memory devices; and
a memory controller operatively coupled to the one or more memory devices and configured to:
detect anomalies in the memory devices;
store anomaly data for the detected anomalies in the memory array;
detect when the stored anomaly data indicates an external attack; and
initiate a countermeasure operation included in firmware of the memory controller in response to detecting the external attack.

2. The memory system of claim 1, wherein the memory controller is configured to insert a random delay in execution of an authentication routine of the firmware in response to detecting the external attack.

3. The memory system of claim 1, wherein the memory controller is configured to perform an authentication routine of the firmware multiple times for authentication in response to detecting the external attack.

4. The memory system of claim 3, wherein the memory controller is configured to:
detect an unsuccessful attempt of authentication in the authentication routine of the firmware; and
initiate, in response to detecting the unsuccessful attempt, a countermeasure that includes one or more of timing out a command, changing a delay in execution of the authentication routine, increasing a number of times the authentication is performed for authentication, and changing sensitivity of anomaly detection.

5. The memory system of claim 1, wherein the memory controller is configured to store a count of detections of a type of anomaly and time between detections of the type of anomaly.

6. The memory system of claim 5, wherein the memory controller includes bit error detection circuitry, and the memory controller is configured to store one or more of a count of memory bit errors and a time between memory bit errors, a count of instruction register errors and a time between instruction register errors, and a count of instruction pointer errors and a time between instruction pointer errors.

7. The memory system of claim 5, wherein the memory system includes voltage sensing circuitry, and the memory controller is configured to store a count of voltage level errors and a time between voltage level errors.

8. The memory system of claim 5, wherein the memory controller is configured to store a count of unsuccessful attempts to access protected memory storage of the memory system and a time between the unsuccessful attempts to access the protected memory storage.

9. The memory system of claim 1, wherein the memory controller is configured to:
store respective counts of detections of respective types of anomalies in the memory array; and
select a countermeasure performable by the firmware according to the stored respective counts of the detections of respective types of anomalies.

10. The memory system of claim 9, wherein the memory controller is configured to:
store a mapping of detectable anomaly types to multiple countermeasures encoded in the firmware; and
select the countermeasure to initiate from the stored mapping according to the stored respective counts of the detections of respective types of anomalies.

11. The memory system of claim 10, wherein the memory controller is configured to weigh the stored respective counts of the detections of the respective types of anomalies differently when selecting the countermeasure.

12. The memory system of claim 1, wherein the memory array includes non-volatile memory, and the memory controller is configured to store the anomaly data in the non-volatile memory.

13. A method of operating a memory system, the method comprising:
detecting anomalies in the memory system;
storing anomaly data in the memory system;
producing an alert status of an external attack according to the anomaly data and recurrently updating the alert status according to collected anomaly data; and
performing a countermeasure operation included in firmware of a memory controller of the memory system in response to the alert status.

14. The method of claim 13, wherein the performing the countermeasure operation includes the memory controller performing firmware instructions that insert a random delay in execution of an authentication routine of the firmware in response to the alert status.

15. The method of claim 13, wherein the performing the countermeasure operation includes the memory controller increasing a number of times that an authentication routine of the firmware is performed by the memory controller for authentication in response to the alert status.

16. The method of claim 15, including:
detecting an unsuccessful attempt of authentication using the authentication routine; and
performing, by the memory controller in response to the unsuccessful attempt in authentication, one or more of timing out a command, changing a delay in execution of the authentication routine, increasing a number of times the authentication is performed for authentication, and changing sensitivity of anomaly detection.

17. The method of claim 13,
wherein the storing the anomaly data includes storing a count of detections of a type of anomaly and time between detections of the type of anomaly; and
wherein the producing the alert status includes updating the alert status when the count of detections and time between detections meet thresholds for detection of a glitch attack.

18. The method of claim 13, including changing firmware of a memory controller of the memory system to change detection criteria for detecting the external attack and a change countermeasure for the external attack.

19. A computer readable storage medium comprising instructions that when performed by processing circuitry of a memory controller of a memory system, cause the memory controller to perform operations including:
detecting anomalies in the memory system;
storing anomaly data in the memory system;
producing an alert status of an external attack according to the anomaly data; and
branching to instructions that cause the memory controller to perform a countermeasure operation to the external attack in response to the alert status.

20. The computer readable storage medium of claim 19, wherein the instructions that cause the memory controller to perform a countermeasure operation include instructions that cause the memory controller to perform operations including one or both of:
inserting a random delay in execution of instructions of a routine performed by the memory controller; and
changing a frequency with which the memory controller performs an authentication routine.
